(19) United States
(12) Patent Application Publication
(10) Pub. No.: US 2010/0203939 A1
(43) Pub. Date: Aug. 12, 2010

(54) Gaming System and a Method of Gaming

(76) Inventor: Richard G. LeBaron, Las Vegas, NV (US)

Correspondence Address: MCANDREWS HELD & MALLOY, LTD, 500 WEST MADISON STREET, SUITE 3400, CHICAGO, IL, 60661, US

(21) Appl. No.: 12/689,025

(22) Filed: Jan. 18, 2010

Related U.S. Application Data
(60) Provisional application No. 61/150,517, filed on Feb. 6, 2009.

(51) Int. Cl. A63F 13/00; A63F 13/10; A63F 13/06; A63F 13/12; A63F 9/24

(52) U.S. Cl. 463/14; 463/43; 463/40; 463/42; 463/31; 463/37

(57) ABSTRACT

A gaming system is disclosed which is arranged to implement a base game and a feature game. The gaming system comprises a trigger determiner arranged to determine whether a trigger condition exists during the base game, and a feature implementer arranged to implement a feature game when a trigger condition exists, the feature game comprising a movable object and an outcome of the feature game being dependent on movement of the object. The system also comprises a touch screen including directional controls usable to control movement of the object by a player during the feature game, and an outcome evaluator arranged to determine whether a game outcome after movement of the object corresponds to a winning outcome. A corresponding method is also disclosed.

### RELATED APPLICATIONS

This application claims priority to U.S. Provisional Patent Application No. 61/150,517 having a priority date of Feb. 6, 2009, which is incorporated herein by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

It is known to provide a gaming system which comprises a game controller arranged to randomly display several symbols from a predetermined set of symbols and to determine a game outcome such as a game win based on the displayed symbols. Such gaming systems may commonly be implemented as a stepper machine provided with reels with each reel carrying several symbols of the set, or a video machine wherein selected symbols are displayed on virtual reels on a graphical display device.

It is also known to provide a gaming system of the type which is arranged to implement a feature game, for example in response to a defined game outcome during a base game. The feature game may be a modified version of the base game or a game which is different to the base game.

However, while such gaming systems provide users with enjoyment, a need exists for alternative gaming systems in order to maintain or increase player enjoyment.

### BRIEF SUMMARY OF THE INVENTION

In accordance with a first aspect of the present invention, there is provided a gaming system arranged to implement a base game, the gaming system comprising:

a trigger determiner arranged to determine whether a trigger condition exists during the base game;

a feature implementer arranged to implement a feature game when the trigger condition exists, the feature game comprising a movable object and an outcome of the feature game being dependent on movement of the object;

a touch screen including directional controls usable to control movement of the object by a player during the feature game; and

an outcome evaluator arranged to determine whether a game outcome after movement of the object corresponds to a winning outcome.

In one embodiment, the gaming system is arranged to communicate with a remote location so as to store feature game data associated with a player at the remote location, the feature game data including information indicative of the feature game state.

In one embodiment, the gaming system is arranged to communicate with a remote location so as to retrieve feature game data associated with a player from the remote location so that a player is able to continue the feature game.

In one embodiment, the gaming system comprises at least one game display, the touch screen being associated with a game display and the directional controls being displayed on the game display.

In one embodiment, the gaming system comprises a player tracking module (PMM) having a PMM display, the touch screen being associated with the PMM and the directional controls being displayed on the PMM display.

The directional controls may comprise a plurality of arrows, each arrow corresponding to a different direction of movement of the object, or a cross having a plurality of legs, each leg corresponding to a different direction of movement of the object.

The feature game may be displayed on the PTM display or on a game display.

In one embodiment, the trigger condition comprises a player input.

In one embodiment, the trigger condition comprises a game event occurring during the base game, such as a defined game outcome or display of one or more defined symbols.

In one embodiment, the number of moves of the object available to a player is predefined, or randomly defined.

In another embodiment, the gaming system comprises a move accumulator arranged to maintain a running total of the number of available moves of an object available to a player, and the gaming system is arranged to increase the number of available moves based on a game event occurring during the base game, such as a defined game outcome or display of one or more defined symbols, or based on the total amount of or type of bets placed.

In one embodiment, the outcome evaluator is arranged to determine whether a game outcome after movement of the object corresponds to a winning outcome after each move of the object, after a defined number of moves, or after a defined completion of the feature game.

In one embodiment, the feature game is a chess game wherein each move corresponds to movement of a chess piece, a treasure hunt type game wherein each move corresponds to a location on a map which may be associated with a prize, or a sport game such as soccer wherein each move corresponds to a direction in which to move a goalkeeper or in which to shoot a soccer ball.

In accordance with a second aspect of the present invention, there is provided a method of gaming comprising:

implementing a base game;

determining whether a trigger condition exists during the base game;

implementing a feature game when the trigger condition exists, the feature game comprising a movable object and an outcome of the feature game being dependent on movement of the object;

providing a touch screen including directional controls usable to control movement of the object by a player during the feature game;

receiving instructions from a player using the directional controls; and

determining whether a game outcome after movement of the object corresponds to a winning outcome.

In accordance with a third aspect of the present invention, there is provided a computer program arranged when loaded into a computer to instruct the computer to operate in accordance with a gaming system comprising:

In accordance with a fourth aspect of the present invention, there is provided a computer readable medium having computer readable program code embodied therein for causing a computer to operate in accordance with a gaming system comprising:

In accordance with a fifth aspect of the present invention, there is provided a data signal having computer readable program code embodied therein for causing a computer to operate in accordance with a gaming system comprising:

### BRIEF DESCRIPTION OF SEVERAL VIEWS OF THE DRAWINGS

The present invention will now be described, by way of example only, with reference to the accompanying drawings, in which:

FIG. 1 is a schematic block diagram of core components of a gaming system in accordance with an embodiment of the present invention;

FIG. 2 is a schematic block diagram of functional components of a gaming system in accordance with an embodiment of the present invention;

FIG. 3 is a diagrammatic representation of a gaming system in accordance with an embodiment of the present invention with the gaming system implemented in the form of a stand alone gaming machine;

FIG. 4 is a schematic block diagram of operative components of the gaming machine shown in FIG. 3;

FIG. 5 is a schematic block diagram of components of a memory of the gaming machine shown in FIG. 3;

FIG. 6 is a schematic diagram of a gaming system in accordance with an alternative embodiment of the present invention with the gaming system implemented over a network;

FIG. 7 is a flow diagram illustrating game play of a gaming system in accordance with an embodiment of the present invention;

FIG. 8 is a diagrammatic representation of an example display during implementation of a feature game by a gaming system in accordance with an embodiment of the present invention and showing directional controls; and

FIG. 9 is a diagrammatic representation of an example display during implementation of a feature game by a gaming system in accordance with an alternative embodiment of the present invention and showing alternative directional controls;

FIG. 10 is a flow diagram illustrating game play of a gaming system in accordance with an alternative embodiment of the present invention; and

FIG. 11 is a diagrammatic representation of an example feature game implemented by a gaming system in accordance with an embodiment of the present invention.

### DETAILED DESCRIPTION OF THE INVENTION

Referring to the drawings, there is shown a schematic block diagram of a gaming system 10 arranged to implement a probabilistic base game of the type wherein several symbols from a set of symbols are randomly displayed, and a game outcome is determined on the basis of the displayed symbols. With some such probabilistic games, the set of symbols include standard symbols and function symbols, and the outcome of the base game is determined on the basis of the displayed standard symbols and the function associated with any displayed function symbol. For example, standard symbols may resemble fruit such as apples, pears and bananas with a win outcome being determined when a predetermined number of the same fruit appear on a display in the same line, scattered, and so on. The function associated with a function symbol may be for example a wild function wherein display of the function symbol is treated during consideration of the game outcome as any of the standard symbols. A function symbol may be represented as the word “WILD”, a star, or by any other suitable word or symbol. Other functions are also envisaged such as scatter functions, multiplier functions, repeat win functions, jackpot functions and feature commencement functions.

In one embodiment of the present gaming system, operation is such that a feature game is triggered when a defined trigger condition exists during implementation of a base game, which may be occurrence of a defined game outcome, occurrence of a game event during a game such as display of a particular symbol, in response to player input, based on the amount or type of bet placed, when a special game is purchased by a player, or based on any other condition. During the feature game, a game arrangement is provided whereby a movable object is displayed on a display of the gaming system and the outcome of the feature game is dependent on the position of the movable object. In order to facilitate movement of the object by a player, directional controls are provided by displaying directional control representations on the display and incorporating a touch screen into the display. In this way, a player is able to control movement of the movable object relative to the screen and thereby influence the outcome of the feature game. One or multiple moves of the object may be allocated to the player depending on the rules of the game.

In another embodiment of the present gaming system, operation is such that as game play progresses a player is able to earn moves in a feature game based on defined criteria, for example when a defined game event occurs during implementation of a base game, based on the amount or type of bet placed, based on the total coin in amount, or based on any other defined criteria. With this embodiment, the gaming system may be arranged so as to enable a player to accumulate moves during play of a base game and to selectively or based on game rules enter the feature game to make one or more moves of the movable object.

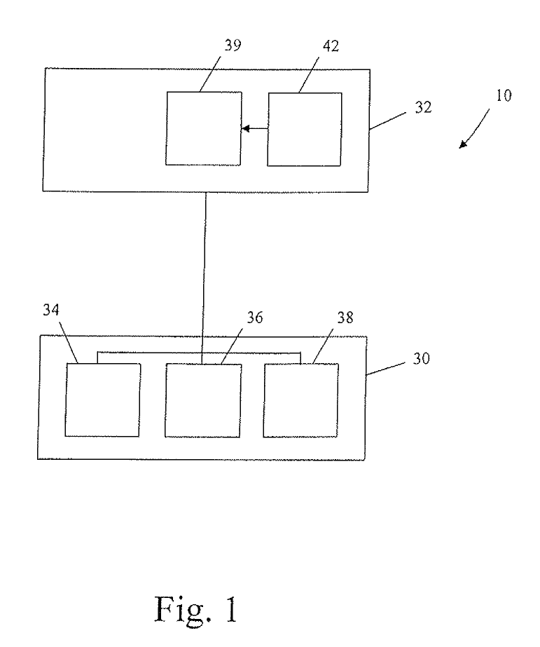

Referring to FIG. 1, a schematic diagram of core components of a gaming system 10 is shown. The core components comprise a player interface 30 and a game controller 32. The player interface 30 is arranged to enable interaction between a player and the gaming system and for this purpose includes input/output components required for the player to enter instructions and play the game.

Components of the player interface 30 may vary but will typically include a credit mechanism 34 to enable a player to input credits and receive payouts, one or more displays 36, at least one of which comprises a touch screen, and a game play mechanism 38 arranged to enable a player to input game play instructions.

The game controller 32 is in data communication with the player interface 30 and typically includes a processor 39 arranged to process game play instructions and output game player outcomes to the display 36. Typically, the game play instructions are stored as program code in a memory 42 that can also be hardwired. It will be understood that in this specification the term “processor” is used to refer generically to any device that can process game play instructions and may include a microprocessor, microcontroller, programmable logic device or other computational device such as a personal computer or a server.

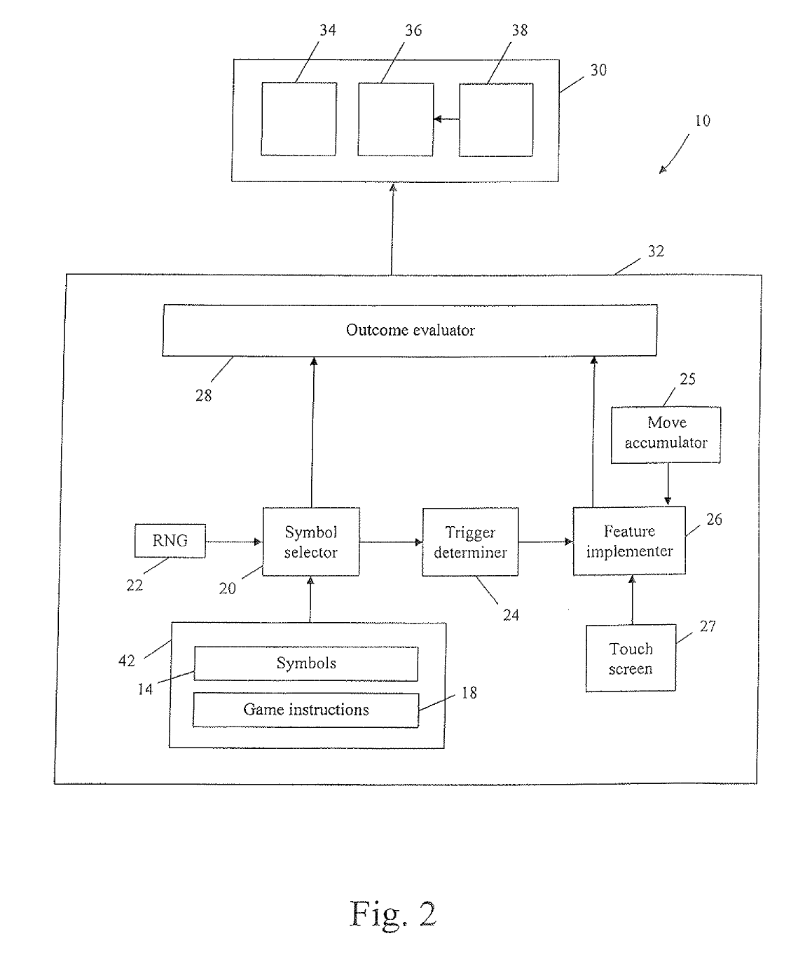

A functional diagram illustrating operative components of the game controller 32 is shown in FIG. 2.

In this example, the memory 42 is arranged to store symbols data 14 for use in a game. The memory 42 is also arranged to store game instruction data 18 indicative of game instructions usable by the gaming machine 10 to control operation of the game.

The game controller 32 includes a symbol selector 20 which is arranged during implementation of a base game to select several symbols from the available symbols 14, in this example by spinning reels containing the symbols and stopping the reels so as to display at least one symbol on each reel. In this example, the selection carried out by the symbol selector 20 is made using a random number generator 22.

It will be appreciated that the random number generator 22 may be of a type which is arranged to generate pseudo random numbers based on a seed number, and that in this specification the term “random” will be understood accordingly to mean truly random or pseudo random.

With this embodiment, the game controller 32 also comprises a trigger determiner 24 arranged to determine whether a trigger condition exists. Occurrence of a trigger condition may cause a feature game to commence wherein a player is able to make one or more moves of an object. A trigger condition may be occurrence of a game event such as a defined game outcome, or may be detection of a defined input from a player.

In one embodiment, the game controller 32 also includes a move accumulator 25 arranged to maintain a running total of moves available to a player, the move accumulator 25 being responsive to one or more game events such that the move total increases when a defined game event occurs.

The gaming system includes a feature implementer 26 arranged to implement a feature game when a trigger condition exists, and a touch screen 27 usable to receive move instructions from a player during a feature game.

The game controller 32 also comprises an outcome evaluator 28 which in accordance with the game instructions 18 determines game outcomes during a base game based on the symbols selected for display to the player by the symbol selector 20, and during a feature game based on the position of a movable object.

In the embodiments described below, the symbol selector 20, the trigger determiner 24, the move accumulator 25, the feature implementer 26 and the outcome evaluator 28 are at least partly implemented using the processor 39 and associated software, although it will be understood that other implementations are envisaged.

The gaming system 10 can take a number of different forms.

In a first form, a stand alone gaming machine is provided wherein all or most components required for implementing the game are present in a player operable gaming machine.

In a second form, a distributed architecture is provided wherein some of the components required for implementing the game are present in a player operable gaming machine and some of the components required for implementing the game are located remotely relative to the gaming machine. For example, a “thick client” architecture may be used wherein part of the game is executed on a player operable gaming machine and part of the game is executed remotely, such as by a gaming server; or a “thin client” architecture may be used wherein most of the game is executed remotely such as by a gaming server and a player operable gaming machine is used only to display audible and/or visible gaming information to the player and receive gaming inputs from the player.

However, it will be understood that other arrangements are envisaged. For example, an architecture may be provided wherein a gaming machine is networked to a gaming server and the respective functions of the gaming machine and the gaming server are selectively modifiable. For example, the gaming system may operate in stand alone gaming machine mode, “thick client” mode or “thin client” mode depending on the game being played, operating conditions, and so on. Other variations will be apparent to persons skilled in the art.

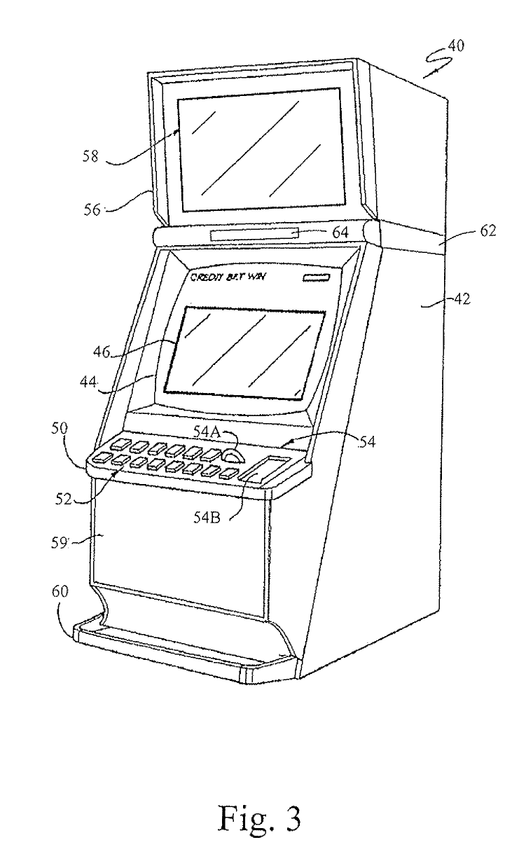

A gaming system in the form of a stand alone gaming machine 40 is illustrated in FIG. 3. The gaming machine 40 includes a console 42 having a primary display 44 on which is displayed representations of a game 46 that can be played by a player. A mid-trim 50 of the gaming machine 40 houses a bank of buttons 52 for enabling a player to interact with the gaming machine, in particular during game play. The mid-trim 50 also houses a credit input mechanism 54 which in this example includes a coin input chute 54A and a bill collector 54B. Other credit input mechanisms may also be employed, for example, a card reader for reading a smart card, debit card or credit card.

A top box 56 in this example includes a secondary display 58 on which a feature game is implemented, although it will be understood that, as an alternative, the feature game may be implemented on the primary display 44. Artwork and/or information may be provided on a front panel 59 of the console 42. A coin tray 60 is mounted beneath the front panel 59 for dispensing cash payouts from the gaming machine 30.

The or each display 44, 58 may be in the form of a video display unit, particularly a cathode ray tube screen device. Alternatively, the or each display 44, 58 may be a liquid crystal display, plasma screen, or any other suitable video display unit. In the present embodiment wherein the secondary display is used to implement a feature game, the secondary display 58 comprises a touch screen usable by a player to control movement of an object during feature game play. In an alternative embodiment wherein the primary display is used to implement a feature game, the primary display 44 comprises a touch screen.

The primary display 44 in this example is arranged to display representations of several reels, each reel of which has several associated symbols. Typically 3, 4 or 5 reels are provided. During operation of a base game, the reels first appear to rotate then stop with typically three symbols visible on each reel. Base game outcomes are determined on the basis of the visible symbols together with any special functions associated with the symbols.

A player marketing module (PMM) 62 having a display 64 is also provided. The PMM 62 allows the player to interact with a player loyalty system. The PMM has a magnetic card reader for the purpose of reading a player tracking device, for example as part of a loyalty program. However other reading devices may be employed and the player tracking device may be in the form of a card, flash drive or any other portable storage medium capable of being read by the reading device. In this example, the PMM 62 is a Sentinel III device produced by Aristocrat Technologies Pty Ltd.

In one embodiment, the PMM 62 includes a touch screen and the display 64 of the PMM 62 is used to display the feature game including directional controls used by a player to control movement of an object during the feature game. Alternatively, the feature game may be displayed on the primary display 44 or the secondary display 58, and the PMM 62 may include a touch screen with the display 64 of the PMM 62 used to display directional controls used by a player to control movement of an object during the feature game.

The PMM 62 may be arranged to communicate with a remote server such that the status of the feature game including the number of available moves remaining, and the position of each object in the feature game are stored at the remote server and are retrievable by a PMM 62 associated with any gaming machine. In this way, a player is able to commence play of a feature game at a gaming machine and subsequently resume feature game play at the same gaming machine or a different gaming machine.

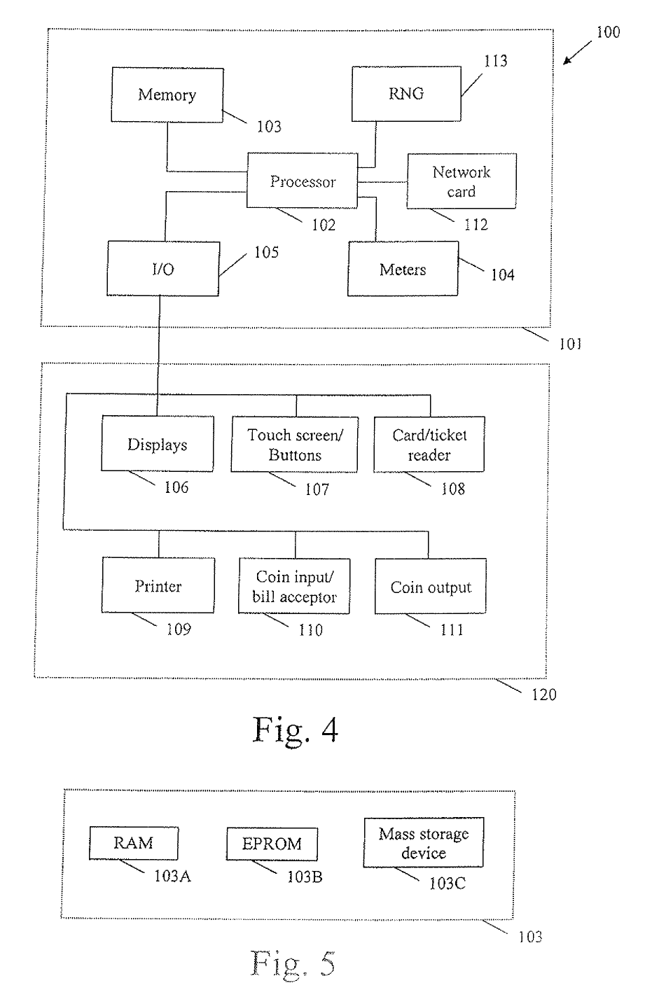

FIG. 4 shows a block diagram of operative components of a gaming machine 100 which may be the same as or different to the gaming machine shown in FIG. 3.

The gaming machine 100 includes a game controller 101 having a processor 102. Instructions and data to control operation of the processor 102 in accordance with the present invention are stored in a memory 103 which is in data communication with the processor 102.

Typically, the gaming machine 100 will include both volatile and non-volatile memory and more than one of each type of memory, with such memories being collectively represented by the memory 103.

FIG. 5 shows a block diagram of the main components of an exemplary memory 103. The memory 103 includes RAM 103A, EPROM 103B and a mass storage device 103C. The RAM 103A typically temporarily holds program files for execution by the processor 102 and related data. The EPROM 103B may be a boot ROM device and/or may contain some system or game related code. The mass storage device 103C is typically used to store game programs, the integrity of which may be verified and/or authenticated by the processor 102 using protected code from the EPROM 103B or elsewhere.

The gaming machine has hardware meters 104 for purposes including ensuring regulatory compliance and monitoring player credit, an input/output (I/O) interface 105 for communicating with a player interface 120 of the gaming machine 100, the player interface 120 having several peripheral devices. The input/output interface 105 and/or the peripheral devices may be intelligent devices with their own memory for storing associated instructions and data for use with the input/output interface or the peripheral devices. A random number generator module 113 generates random numbers for use by the processor 102.

In the example shown in FIG. 4, the peripheral devices that communicate with the game controller 101 comprise one or more displays 106, a touch screen and bank of buttons 107, a card and/or ticket reader 108, a printer 109, a bill acceptor and/or coin input mechanism 110 and a coin output mechanism 111. Additional hardware may be included as part of the gaming machine 100, or hardware may be omitted as required for the specific implementation.

In addition, the gaming machine 100 may include a communications interface, for example a network card 112. The network card may, for example, send status information, accounting information or other information to a central controller, server or database and receive data or commands from the central controller, server or database.

It is also possible for the operative components of the gaming machine 100 to be distributed, for example input/output devices 106, 107, 108, 109, 110, 111 may be provided remotely from the game controller 101.

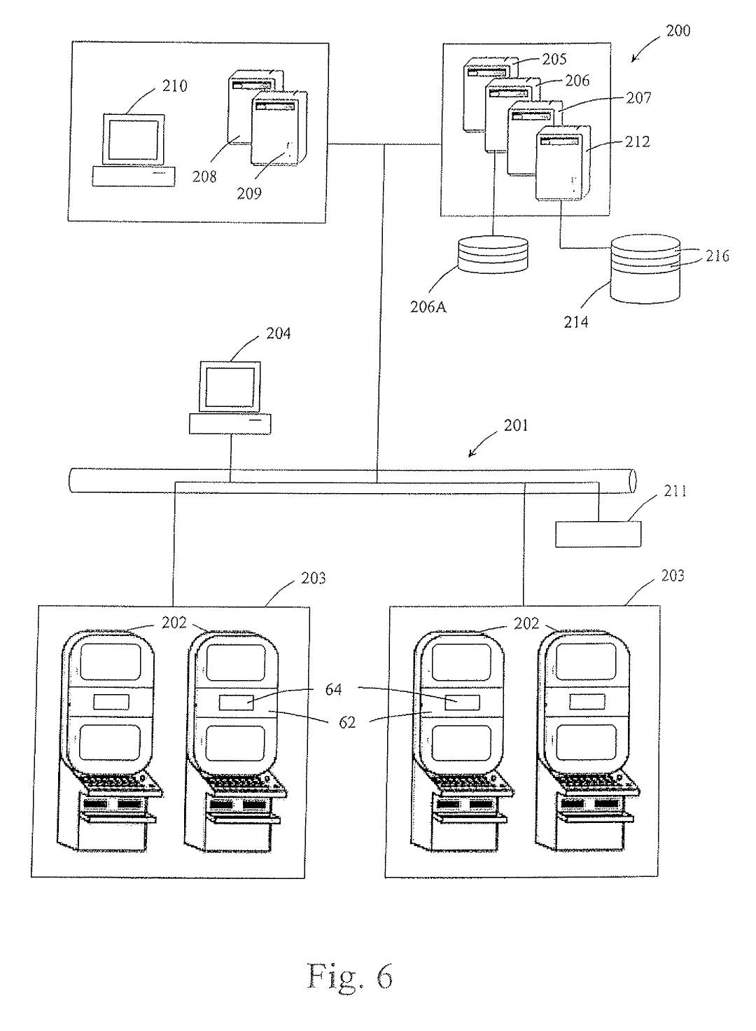

FIG. 6 shows a gaming system 200 in accordance with an alternative embodiment. The gaming system 200 includes a network 201, which for example may be an Ethernet network, a LAN or a WAN. In this example, two banks 203 of two gaming machines 202 are connected to the network 201. The gaming machines 202 provide a player operable interface and may be the same as the gaming machines 40,100 shown in FIGS. 3 and 4, or may have simplified functionality depending on the requirements for implementing game play. While banks 203 of two gaming machines are illustrated in FIG. 6, banks of one, three or more gaming machines are also envisaged.

One or more displays 204 may also be connected to the network 201. The displays 204 may, for example, be associated with one or more banks 203 of gaming machines. The displays 204 may be used to display representations associated with game play on the gaming machines 202, and/or used to display other representations, for example promotional or informational material.

In a thick client embodiment, a game server 205 implements part of the game played by a player using a gaming machine 202 and the gaming machine 202 implements part of the game. With this embodiment, as both the game server 205 and the gaming machine 202 implement part of the game, they collectively provide a game controller. A database management server 206 may manage storage of game programs and associated data for downloading or access by the gaming devices 202 in a database 206A. Typically, if the gaming system enables players to participate in a Jackpot game, a Jackpot server 207 will be provided to monitor and carry out the Jackpot game.

In a variation of the above thick client embodiment, the gaming machine 202 may implement the game, with the game server 205 functioning merely to serve data indicative of a game to the gaming machine 202 for implementation.

With this implementation, a data signal containing a computer program usable by the client terminal to implement the gaming system may be transferred from the game server to the client terminal, for example in response to a request by the client terminal.

In a thin client embodiment, the game server 205 implements most or all of the game played by a player using a gaming machine 202 and the gaming machine 202 essentially provides only the player interface. With this embodiment, the game server 205 provides the game controller. The gaming machine will receive player instructions, and pass the instructions to the game server which will process them and return game play outcomes to the gaming machine for display. In a thin client embodiment, the gaming machines could be computer terminals, e.g. PCs running software that provides a player interface operable using standard computer input and output components.

Servers are also typically provided to assist in the administration of the gaming system 200, including for example a gaming floor management server 208 and a licensing server 209 to monitor the use of licenses relating to particular games. An administrator terminal 210 is provided to allow an administrator to monitor the network 201 and the devices connected to the network.

The gaming system 200 may communicate with other gaming systems, other local networks such as a corporate network, and/or a wide area network such as the Internet, for example through a firewall 211.

The gaming system 200 also comprises a loyalty program server 212 and a feature database 214. The loyalty program server 212 is arranged to communicate with the player marketing modules (PMM) 62 of gaming machines 202 associated with the gaming system 200 so as to track player behaviour and, in one embodiment, so as to store feature game data including data indicative of the type of feature game to be implemented at a gaming machine, and the game state of the feature game so that the feature game may be continued on a different gaming machine. In this example, for this purpose, the feature database 214 includes a plurality of feature game records 216, each feature game record 216 being associated with a player and being arranged to store feature game data associated with the player.

Persons skilled in the art will appreciate that in accordance with known techniques, functionality at the server side of the network may be distributed over a plurality of different computers. For example, elements may be run as a single “engine” on one server or a separate server may be provided. For example, the game server 205 could run a random number generator engine. Alternatively, a separate random number generator server could be provided.

During a base game, a plurality of reels are provided, with each reel comprising standard symbols and optionally one or more function symbols. Win outcomes are determined on the basis of the symbols visible at the display positions when the reels stop rotating.

The gaming system is arranged to implement one or more feature games. A feature game may commence automatically on the basis of occurrence of a trigger condition, such as a game event occurring during a base game, or in response to player input.

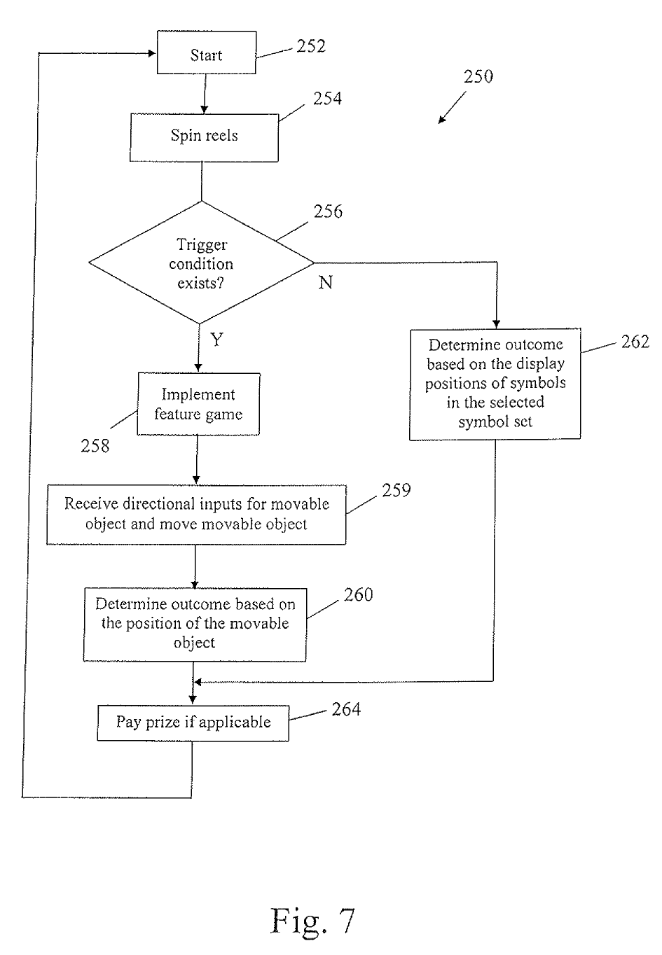

A specific example will now be described in relation to flow diagram 250 shown in FIG. 7 which illustrates steps 252 to 264 of a method of gaming implemented by a gaming system. In this example, the gaming machine is a stand alone gaming machine 40.

In this example, five virtual reels are provided and, as such, representations of the reels are displayed on a graphical display device 44 of a gaming machine 40. The gaming machine 40 in this example includes a secondary display 58 and a touch screen associated with the secondary display 58.

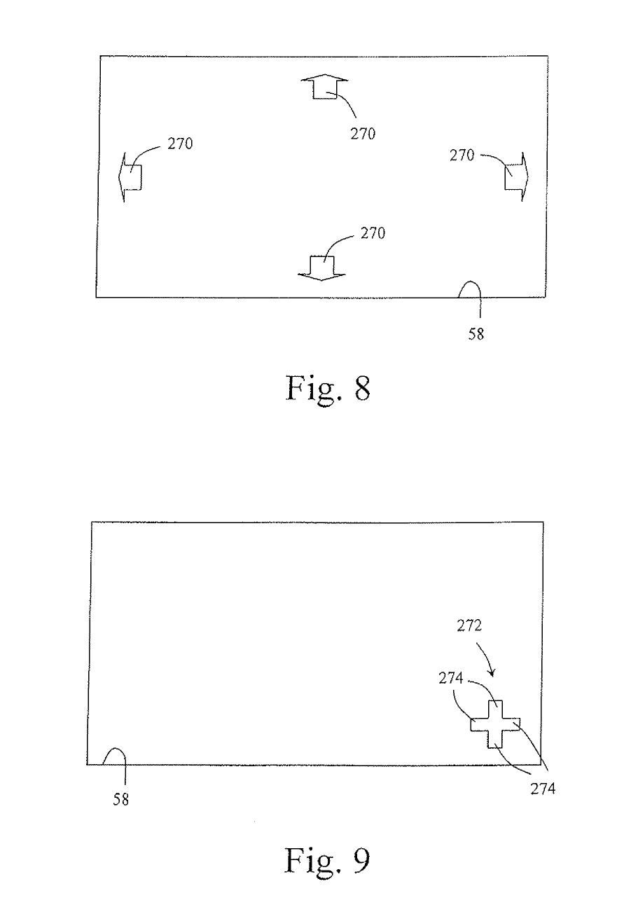

In this example, the gaming system is arranged to commence a feature game 258 when a trigger condition exists in the form of appearance of a particular symbol combination such as a defined number of scattered symbols. When a trigger condition occurs 256 after a reel spin 254, directional controls are shown on the secondary display 58 which are used to control movement of an object in the feature game, as shown in FIG. 8. In this example, the directional controls 270 appear as arrows distributed adjacent edges of the secondary display 58. As an alternative, the directional controls may take the form of a cross 272 as shown in FIG. 9, respective legs 274 of which are used to control movement of an object. The number of moves available to a player may be predefined, may be randomly selected, or may accumulate based on game events occurring during base game play.

The feature game may be of any type wherein the game outcome is dependent on the position of a movable object, for example a strategy type game such as chess, a search game of the type such as a treasure hunt wherein with each move a player moves a character to a location on a map which potentially contains a prize, a sport type game such as soccer wherein with each move a player controls the direction of a goalkeeper or the shot direction of a soccer character, or any other game wherein movement of an object by a player influences the outcome of the game.

After each movement of the movable object, after all available moves have been made, or after the feature game reaches a state of completion, the gaming system determines an outcome of the feature game 260 and a prize is paid if applicable 264.

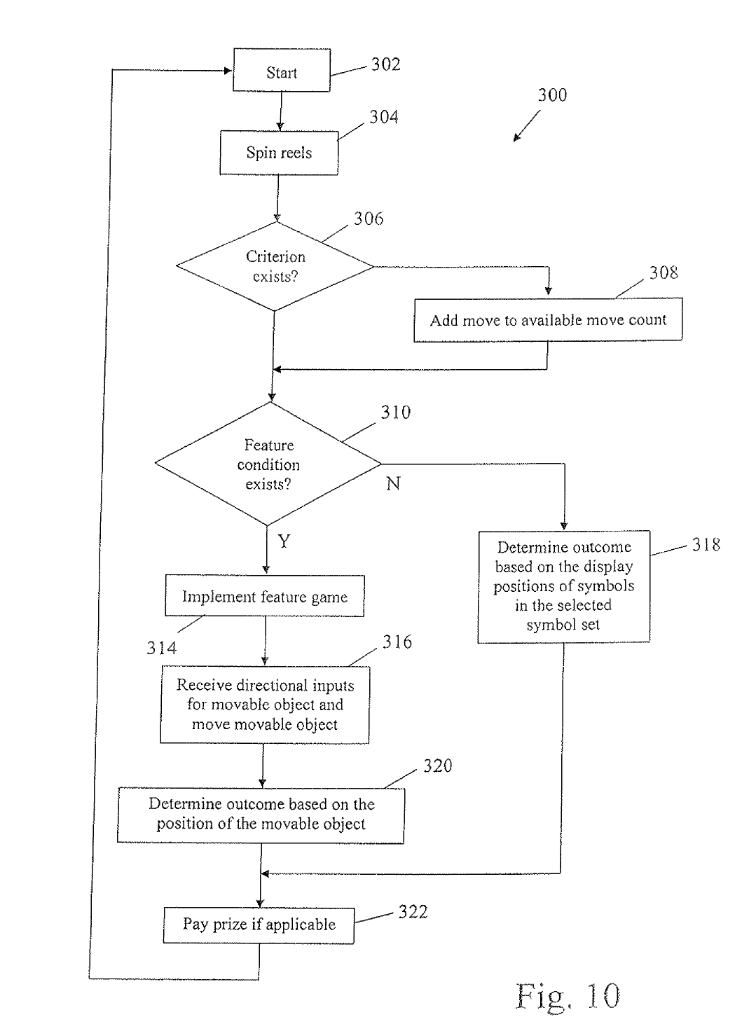

A further specific example will now be described in relation to flow diagram 300 shown in FIG. 10 which illustrates steps 302 to 322 of a method of gaming implemented by a gaming system. In this example, the gaming machine is a networked gaming machine 202 of the type shown in FIG. 6.

In this example, five virtual reels are provided and, as such, representations of the reels are displayed on a graphical display device 44 of a gaming machine 202. The gaming machine 202 in this example includes a PMM display 64 and a touch screen associated with the PMM display 64.

In this example, the gaming system is arranged to commence a feature game 314 when a trigger condition exists in the form of a player input indicative that the player wishes to commence the feature game. When the trigger condition occurs 310, directional controls are shown on the PMM display 64 which are used to control movement of an object in the feature game. In this embodiment, the number of moves available to a player accumulate based on game outcomes occurring during base game play, and the feature game may be caused to commence by a player at any time.

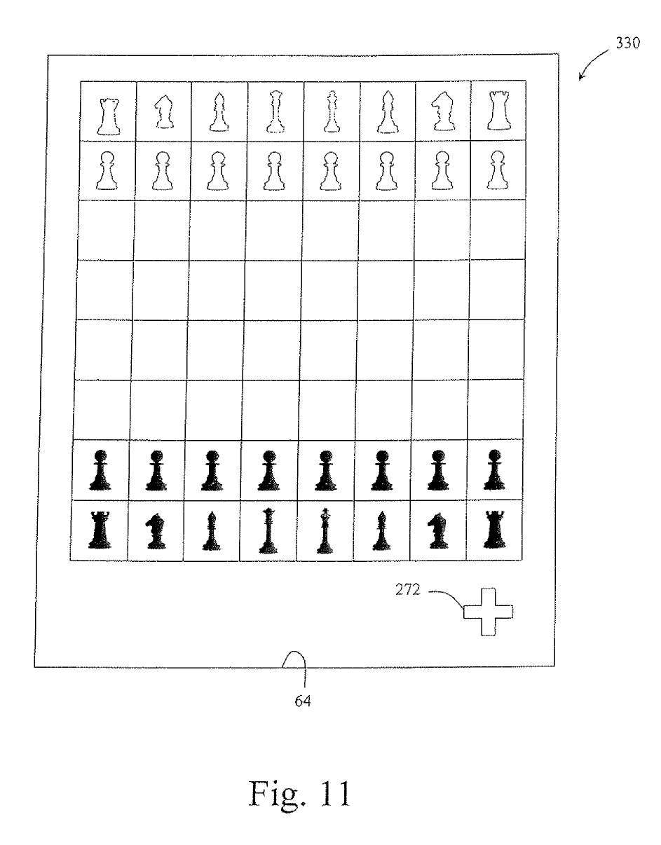

The feature game in this example is a chess game 330 as shown in FIG. 11. The chess game 330 may be displayed on the PMM 64 together with the directional controls as shown in FIG. 11, or the chess game may be displayed on the primary or secondary display with the directional controls shown on the PTM display 64.

With each available move, a player may make any valid move of the player's chess pieces according to the rules of chess, after which the gaming machine 202 will automatically move one of the machine's chess pieces. After completion of the chess game, the gaming system determines whether the player has won the chess game or whether other feature game conditions correspond to a winning outcome and a prize is paid if appropriate.

In this example, the gaming machine 202 is in networked communication with the loyalty program server 212 which is arranged to store details of the current feature game in a feature game record 216 such as the current state of the feature game including in this example the current position of the chess pieces. After each move has been made by a player, the feature game record 116 is updated. When a player wishes to recommence the feature game, either from the same gaming machine or from a different gaming machine, the gaming machine 202 communicates with the loyalty program server and retrieves the required data from the relevant feature game record 116 in order that the feature game may be recommenced.

It will be understood that, in this way, a player is able to earn moves for a feature game during normal base game play, and to make moves for the feature game from any gaming machine associated with the gaming system.

Modifications and variations as would be apparent to a skilled addressee are deemed to be within the scope of the present invention.

1. A gaming system arranged to implement a base game, the gaming system comprising:
a trigger determiner arranged to determine whether a trigger condition exists during the base game;
a feature implementer arranged to implement a feature game when the trigger condition exists, the feature game comprising a movable object and an outcome of the feature game being dependent on movement of the object;
a touch screen including directional controls usable to control movement of the object by a player during the feature game; and
an outcome evaluator arranged to determine whether a game outcome after movement of the object corresponds to a winning outcome.

2. A gaming system as claimed in claim 1, wherein the gaming system is arranged to store feature game data associated with a player, the feature game data including information indicative of the feature game state, and the gaming system being arranged to selectively implement the feature game or the base game in response to player input.

3. A gaming system as claimed in claim 2, wherein the gaming system is arranged to communicate with a remote location so as to store the feature game data at the remote location.

4. A gaming system as claimed in claim 3, comprising a plurality of gaming machines, each gaming machine being arranged to communicate with a remote location so as to retrieve feature game data associated with a player from the remote location so that a player is able to selectively continue the feature game from any one of the gaming machines.

5. A gaming system as claimed in claim 1, wherein the gaming system comprises at least one game display, the touch screen being associated with a game display and the directional controls being displayed on the game display.

6. A gaming system as claimed in claim 5, wherein the feature game is displayed on the game display.

7. A gaming system as claimed in claim 1, wherein the gaming system comprises a player tracking module (PMM) having a PMM display, the touch screen being associated with the PMM and the directional controls being displayed on the PMM display.

8. A gaming system as claimed in claim 7, wherein the feature game is displayed on the PMM display.

9. A gaming system as claimed in claim 1, wherein the directional controls comprise a plurality of arrows, each arrow corresponding to a different direction of movement of the object.

10. A gaming system as claimed in claim 1, wherein the directional controls comprise a cross having a plurality of legs, each leg corresponding to a different direction of movement of the object.

11. A gaming system as claimed in claim 1, wherein the trigger condition comprises a player input.

12. A gaming system as claimed in claim 1, wherein the trigger condition comprises a game event occurring during the base game.

13. A gaming system as claimed in claim 11, wherein the game event is a defined game outcome or display of one or more defined symbols.

14. A gaming system as claimed in claim 1, wherein the number of moves of the object available to a player is predefined, or randomly defined.

15. A gaming system as claimed in claim 1, comprising a move accumulator arranged to maintain a running total of the number of available moves of an object available to a player, and the gaming system is arranged to increase the number of available moves based on defined criteria.

16. A gaming system as claimed in claim 15, wherein the defined criteria comprises a game event occurring during the base game.

17. A gaming system as claimed in claim 16, wherein the game event is a defined game outcome or display of one or more defined symbols.

18. A gaming system as claimed in claim 15, wherein the defined criteria comprises the total amount of or type of bets placed.

19. A gaming system as claimed in claim 1, wherein the outcome evaluator is arranged to determine whether a game outcome after movement of the object corresponds to a winning outcome after each move of the object, after a defined number of moves, or after a defined completion of the feature game.

20. A gaming system as claimed in claim 1, wherein the feature game is a chess game wherein each move corresponds to movement of a chess piece, a treasure hunt type game wherein each move corresponds to a location on a map which may be associated with a prize, or a sport game such as soccer wherein each move corresponds to a direction in which to move a goalkeeper or in which to shoot a soccer ball.

21. A method of gaming comprising:
implementing a base game;
determining whether a trigger condition exists during the base game;
implementing a feature game when the trigger condition exists, the feature game comprising a movable object and an outcome of the feature game being dependent on movement of the object;
providing a touch screen including directional controls usable to control movement of the object by a player during the feature game;
receiving instructions from a player using the directional controls; and
determining whether a game outcome after movement of the object corresponds to a winning outcome.

22. A method as claimed in claim 21, comprising storing feature game data associated with a player, the feature game data including information indicative of the feature game state, and selectively implementing the feature game or the base game in response to player input.

23. A method as claimed in claim 22, comprising communicating with a remote location so as to store the feature game data at the remote location.

24. A method as claimed in claim 23, comprising providing a plurality of gaming machines, each gaming machine being arranged to communicate with a remote location so as to retrieve feature game data associated with a player from the remote location so that a player is able to selectively continue the feature game from any one of the gaming machines.

25. A method as claimed in claim 21, comprising providing at least one game display, the touch screen being associated with a game display, and displaying directional controls on the game display.

26. A method as claimed in claim 25, comprising displaying the feature game on the game display.

27. A method as claimed in claim 21, comprising providing a player tracking module (PMM) having a PMM display, the touch screen being associated with the PMM, and displaying the directional controls on the PMM display.

28. A method as claimed in claim 27, comprising displaying the feature game on the PMM display.

29. A method as claimed in claim 21, wherein the directional controls comprise a plurality of arrows, each arrow corresponding to a different direction of movement of the object.

30. A method as claimed in claim 21, wherein the directional controls comprise a cross having a plurality of legs, each leg corresponding to a different direction of movement of the object.

31. A method as claimed in claim 21, wherein the trigger condition comprises a player input.

32. A method as claimed in claim 21, wherein the trigger condition comprises a game event occurring during the base game.

33. A method as claimed in claim 32, wherein the game event is a defined game outcome or display of one or more defined symbols.

34. A method as claimed in claim 21, wherein the number of moves of the object available to a player is predefined, or randomly defined.

35. A method as claimed in claim 21, comprising maintaining a running total of the number of available moves of an object available to a player, and increasing the number of available moves based on defined criteria.

36. A method as claimed in claim 35, wherein the defined criteria comprises a game event occurring during the base game.

37. A method as claimed in claim 36, wherein the game event is a defined game outcome or display of one or more defined symbols.

38. A method as claimed in claim 35, wherein the defined criteria comprises the total amount of or type of bets placed.

39. A method as claimed in claim 21, comprising determining whether a game outcome after movement of the object corresponds to a winning outcome after each move of the object, after a defined number of moves, or after a defined completion of the feature game.

40. A method as claimed in claim 21, wherein the feature game is a chess game wherein each move corresponds to movement of a chess piece, a treasure hunt type game wherein each move corresponds to a location on a map which may be associated with a prize, or a sport game such as soccer wherein each move corresponds to a direction in which to move a goalkeeper or in which to shoot a soccer ball.

41. A gaming system as claimed in claim 1, further comprising a computer program arranged to be loaded into a computer, and to instruct the computer to operate the gaming system.

42. A gaming system as claimed in claim 41, further comprising a computer readable medium having said computer readable program code embodied therein for causing said computer to operate in accordance with said gaming system.

43. A gaming system as claimed in claim 41, further comprising a data signal indicative of said computer readable program code embodied therein for causing said computer to operate in accordance with said gaming system.
